(19) United States
(12) Patent Application Publication
(10) Pub. No.: US 2015/0211618 A1
(43) Pub. Date: Jul. 30, 2015

(54) ELECTRO POWERED MECHANICAL DEVICE FOR POWER GENERATION

(71) Applicant: Manuel BARROSO TAVARES, Entroncamento (PT)

(72) Inventor: Manuel Barroso Tavares, Entroncamento (PT)

(21) Appl. No.: 14/424,565

(22) PCT Filed: Aug. 30, 2013
(86) PCT No.: PCT/IB2013/058162

§ 371 Date: Feb. 27, 2015

(30) Foreign Application Priority Data
Sep. 3, 2012 (PT) 106515

(51) Int. Cl. F16H 37/12; H02K 7/10

(52) U.S. Cl. CPC F16H 37/12; H02K 7/10

(57) ABSTRACT

The present invention relates to an electro powered mechanical power generation device, using interconnected wheels of different sizes. The device comprises several wheels, in which the main wheel, after having been set in motion by the power source drives the wheels sent via levers, which in turn will drive pulley generator rotor causing it to rotate, producing electricity.

### FIELD OF THE INVENTION

The present invention relates to a device for the production of electricity driven by a conventional source of driving power generated by thermal power, hydraulic power, wind power, etc. or any other power source.

### BACKGROUND OF THE INVENTION

There are currently several ways to produce clean, renewable energy, namely, various forms of driving the generators either of AC or DC. However, all these models involve very high production and maintenance costs.

Even though there are many published documents describing devices for energy production, and the equipment described in the invention uses various mechanical parts that are common in the art, it has not been detected any document that describes an equipment with the same sequence of parts nor that uses the method described herein, for the production of energy.

### ADVANTAGES OF THE INVENTION

The main advantage of the invention is to provide a device easy to produce at a low cost, which can be installed in locations where the installation of conventional equipment for power production is not feasible.

It also has the advantage of being able to use as any source of electrical energy obtained from conventional sources (thermal, hydro, wind, solar, etc.), or any other power source.

### BRIEF DESCRIPTION OF THE DRAWINGS

These and other features can be readily understood by reference to the accompanying drawings, which should be regarded solely as examples and do not in any way as restricting the scope of the invention.

FIGS. 1 and 2 show, respectively, a side view and a top view of the device of the invention.

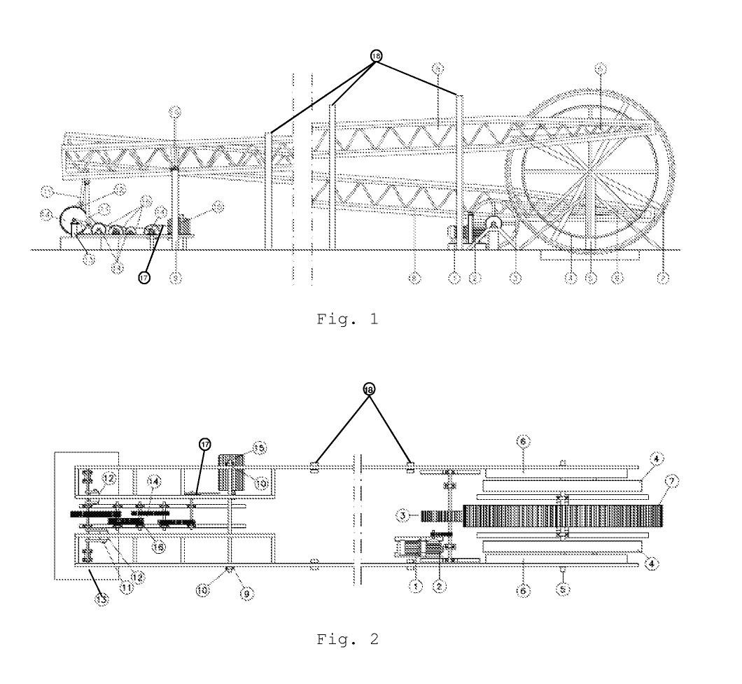

Are visible therein its various components: power source (1), reducer (2), ratchet wheel (3), wheels (4), support of the wheels (5), cursors (6), main wheel (7), levers (8), support of the levers (9), fulcrum of the levers (10), stays of the rods (11), rods (12), support of the rods (13), driven gear (14) generator (15), belt/chain (16), chain (17) and lever balancing device (18).

### DETAILED DESCRIPTION OF THE INVENTION

The present invention relates to a device for the production of electrical energy in a cheap, clean and renewable manner.

The device comprises power source (1), reducer (2), ratchet wheel (3), wheels (4), support of the wheels (5), cursors (6), main wheel (7), levers (8), support of the levers (9), fulcrum of the levers (10),stays of the rods (11), rods (12), support of the rods (13), driven gear (14), generator (15), belt/chain (16), chain (17) and lever balancing device (18).

The lever balancing devices (18), that depend on the length of the levers may be more than one in number, are positioned along the levers (8) serving to support the same.

The combinations of driven gear (14) and belt/chain (16), may be in a quantity greater than one, depending the quantity on the number of rotations that must be available in the generator.

The device is set in motion by the power source (1) which sets the reducer (2) in motion. This, after reducing the number of revolutions to a number that enables the operation of the remaining components of the apparatus through the ratchet wheel (3) drives the main wheel (7). The revolution of this main wheel (7) sets the wheels (4) in motion. The cursors (6) that are coupled to the wheels (4) set the levers (8) in motion. These components are supported by the support of the wheels (5). The levers (8) which are attached to the support of the levers (9) where the fulcrum of the lever (10) is located, when they transmit movement to the rods (12) which are supported by the support of the rods (13) through the stays of the rods (11) set in motion the first set comprising the driven gear (14) and belt/chain (16) which, in turn, transmit movement to the others. The last chain (17) transmits motion to the pulley of the rotor of the generator (15) causing it to rotate, producing power.

1-3. (canceled)

4. An electro powered mechanical energy generation device comprising:
a reducer which, in use, is set in motion by a power source;
a ratchet wheel which, in use, is set in motion by the reducer;
a main wheel which, in use, is set in motion by the ratchet wheel;
a support for the wheels, and wheels each having a cursor coupled thereto, which, in use, are set in motion by the main wheel;
a plurality of support for the levers, and levers which, in use, are set in motion by the cursors;
rods and support of the rods; and
a combination comprising: a first wheel set, which, in use, is set in motion by the levers, comprising a driven gear and a first belt/chain; and a last chain, whereby the last chain transmits motion to a pulley of a generator for producing electrical current.

5. The device according to claim 1, wherein the power source is fed by a conventional or unconventional power source.

6. A method for operating an electro powered mechanical energy generation device comprising the following steps:
a power source sets a reducer in motion;
the reducer, after reducing the number of rotations, sets a ratchet wheel in motion;
the ratchet wheel transmits the motion to a main wheel;
the movement of the main wheel is transmitted to the wheels;
cursors are coupled to the wheels that set levers in motion;
rods, set in motion by the levers through the stays of the rods, drive the first wheel set comprising a driven gear and a belt/chain, which in turn transmits movement to the following:
the last chain transmits motion to a pulley of the rotor of a generator causing it to rotate, producing electric current.
